(19) United States
(12) Patent Application Publication
(10) Pub. No.: US 2013/0041401 A1
(43) Pub. Date: Feb. 14, 2013

(54) Disposable acupressure relief strip

(71) Applicant: Joseph Di Lustro, Tinton Falls, NJ (US)

(72) Inventor: Joseph Di Lustro, Tinton Falls, NJ (US)

(73) Assignee: Pressure Point Inc

(21) Appl. No.: 13/573,218

(22) Filed: Aug. 31, 2012

Related U.S. Application Data
(63) Continuation-in-part of application No. 12/658,717, filed on Feb. 16, 2010.
Application No. 12/658,717 is a continuation-in-part of application No. 11/490,274, filed on Jul. 21, 2006, now abandoned.

(51) Int. Cl. A61H 11/00

(52) U.S. Cl. 606/204

(57) ABSTRACT

A disposable acupressure strip providing 72 hours of nausea and vomiting relief for surgery and cancer treating patients includes a raised portion of a contact button extending from a film substrate through a cutout positioned over the P6 pericardium acupressure point on a user's wrist and secured there by a medical grade surgical adhesive tape.

### CROSS-REFERENCE TO RELATED APPLICATIONS

This Application is a Continuation-in-Part of application Ser. No. 12/658,717 filed Feb. 16, 2010, which is a Continuation-in-Part of application Ser. No. 11/490,274 filed Jul. 21, 2006.

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

NOT APPLICABLE

### BACKGROUND OF THE INVENTION

1. Field of the Invention

This invention relates to acupressure sensory relief, in general, and to a disposable acupressure neuro-stimulating wrist strip, in particular.

2. Description of the Related Art

As is understood in the medical and surgical community, approximately 50 percent of all surgical procedures are impacted by postoperative nausea and vomiting (PONY). The usual procedure to deal with this is for an anesthesiologist to provide an anti-sickness drug before an anesthesia is administered—and then, to provide a further drug when the patient comes out of the surgery (i.e., “Drug Rescue Therapy”). Unfortunately, even this does not always work. As is also understood, similar administrations of drugs are made to prevent chemo induced nausea and vomiting (CINV), but with comparable less-than-optimum results.

Recent research in the field report a degree of success in the use of acupressure to alleviate postoperative nausea and vomiting, especially in ambulatory surgery. Likewise, research has indicated a degree of success of acupressure in preventing nausea and vomiting in chemotherapy treatments, beyond the use of antiemetic drugs. In each instance the use of acupressure reduced the incidence of nausea and vomiting.

Although acupressure wrist bands have been utilized in the past for the casual prevention of nausea (as for travel motion sickness and early pregnancy nausea prevention), they typically sell for about $10.00-$12.00 per pair, one for each hand. As will become clear from the following description, however, the acupressure relief afforded by the present invention not only obviates the hassle accompanying a medical patient's attempted use of such bands, but also provides a concomitant reduction in cost when tailored for use by a medical or surgical staff. As will become clear, the acupressure relief of the invention is provided—not by a band which encircles the wrist but through a strip which lies along the inside of the wrist—and is at the same time disposable, hypoallergenic and skin contact friendly. As will also become clear, the neuro-stimulating wrist strip of the invention is the first to meet U.S. Food and Drug Administration regulations in establishing protection requirements for users of acupressure devices in an attempt to reduce motion sickness and of nausea and vomiting after surgery.

### SUMMARY OF THE INVENTION

Intended to achieve maximum stimulation of up to 72 hours to relieve nausea and vomiting effects, the disposable acupressure relief strip of the invention is first designed for positioning at the pericardium 6, (P6 meridian point on the wrists). To accomplish this, a tape substrate of prescribed length and width with an overlying liner of paper is employed. A light weight surgical adhesive tape is provided in satisfying FDA regulations for human use bio-compatibility, with a cutout through the tape to the liner across the width of the strip. To apply the acupressure, a bumper or contact button is adhered to the lamination, with a raised portion extending downward through the cutout. In a preferred construction, the raised contact portion is of a circular configuration, and the papered liner is peelable away from the adhesive lamination at opposing sides of the cutout.

In this preferred construction, the strip includes a plastic tape in the nature of a transparent perforated polyolefin film which is hypoallergenic, which is easy to tear bi-directionally, and which offers strong adhesion and visualization of the skin underneath. The bumper or contact button is of a hard medical grade injection-molded plastic composition, with an elastomer coated raised portion which does not irritate the skin where the contact is made, and its centerline is located 1½ inches in from a first side edge on the width of the surgical adhesive tape strip. The pressure sensitive adhesive backing is of a high performance adhesive of a thin polyester film.

So as to assure that the movement activity of the wrist over time (even while sleeping) doesn't dislodge the substrate from the skin, the light weight surgical adhesive tope is of a width not less than one inch. So as to assure that the bumper or contact button remains secure on the P6 pressure point and not lift from the skin surface, the surgical adhesive tape is of a minimum of 5½ inches in length. So as to assure a reliable level of acupressure is reached in order to be effective in anti-nausea and vomiting cases associated with chemotherapy, surgical/procedures, morning sickness and motion sickness, the bumper or contact button of the invention is composed of an injection-molded hard plastic in the shape of a dome sufficient to produce up to 5-7 pounds-per square inch downwardly applied pressure at a depth-specific 0.5-1.0 inches below the skin surface to achieve neuro-pressure stimulation.

As will be appreciated by those knowledgeable in the art, a pair of such tape-button, strip combinations are utilized together—one along each wrist, bilaterally. An acupressure relief package including two of these strips can thus be provided within a pouch, according to the invention, with instructions for use printed directly on the pouch. One advantage of this will be seen to be that several such pouches could be removed from a box in which they come, to be taken to different operating rooms from a single supply center—without having to worry about the instructions for use only being printed on the box; this way, each member of the professional staff who emplaces or removes the strip on or from a patient has his/her own set of instructions available to them.

And, as such, in this respect, the acupressure relief strip of the invention, becomes a prescription-based, FDA-approved medical device for mitigating the effects of nausea and vomiting for surgical patients, as well as to reduce chemo-induced nausea and vomiting in cancer patients.

### BRIEF DESCRIPTION OF THE DRAWINGS

These and other features of the present invention will be more clearly understood from a consideration of the following description, taken in connection with the accompanying drawings, in which:

FIGS. 1a-1d are illustrations helpful in an understanding of the use of the disposable acupressure relief strip of the invention;

FIGS. 2a and 2b are top and side views of the relief strip;

FIG. 3 is an illustration of the raised bumper or contact button which extends through a cutout on the relief strip according to the invention;

FIG. 4 illustrates a packaging for a pair of such disposable acupressure relief strips, one for each wrist; and

FIG. 5 is a view of a pericardium P6 locator guide helpful in carrying out the teachings of the invention.

### DETAILED DESCRIPTION OF THE INVENTION

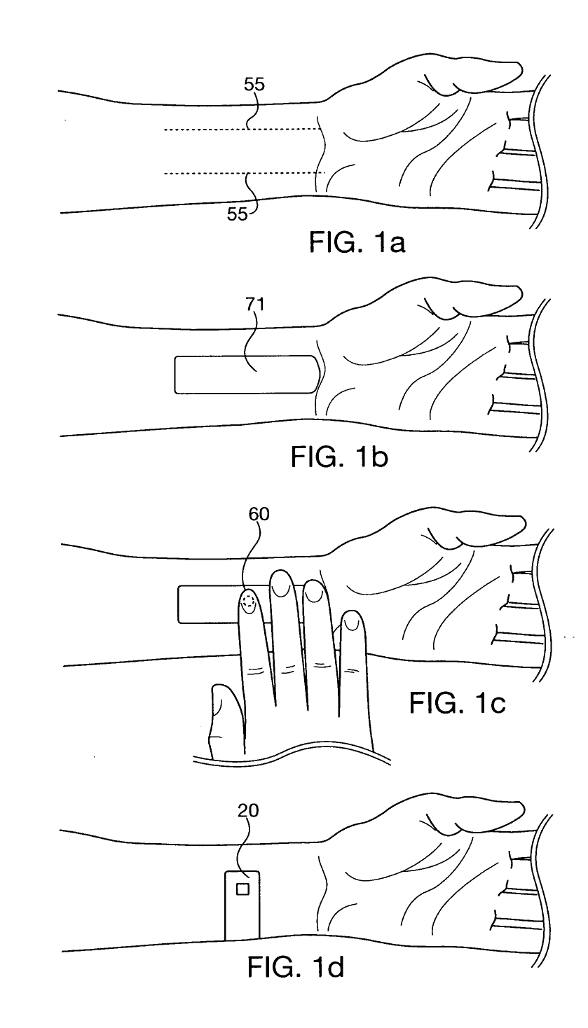

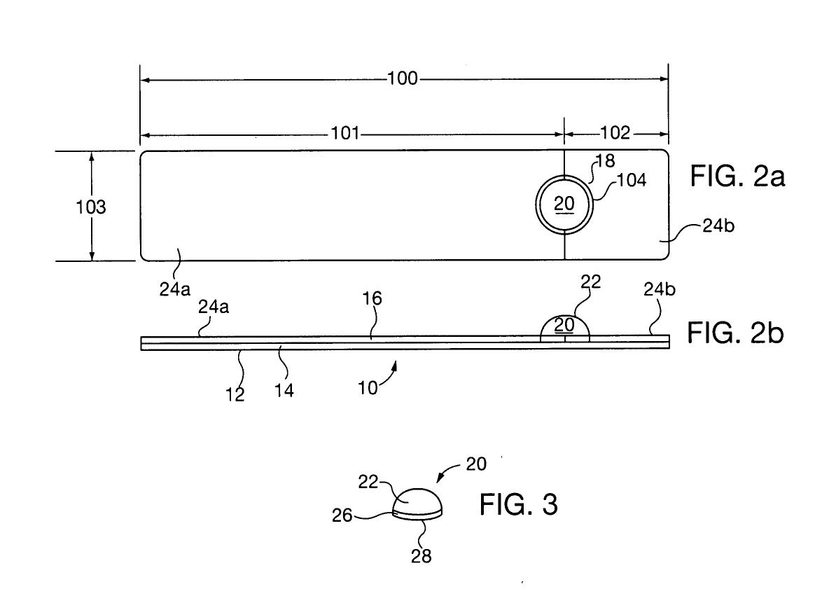

FIGS. 1a-1d, 2a-2b and 3 show the substrate of the disposable acupressure relief strip at 10, the transparent perforated film at 12, the light weight surgical adhesive lamination at 14, the overlying paper liner at 16 and the paper liner cutout at 18. The hard medical grade plastic bumper or contact button is shown at 20, with its raised portion shown as a dome at 22. As will be appreciated, a button of such composition is bio-compatible with human skin use pressurizings.

The positioning of the acupressure relief strip of the invention for bilateral use on both wrists follows the placing of the first three fingers on the wrist crease on its inside, to locate where the P6 pressure point is situated between the two flex tendons 55 (i.e., under the index finger), as at 60. The paper liner 16 of the relief strip is then peeled off on one side 24a of the cutout 18, then off the other side 24b. The elastomer coated contact button 20 that extends through the cutout is then placed face down with its raised contact portion on the P6 pressure point 60 of the wrist. The adhesive lamination 14 that is exposed by the peeling off of the paper liner 16 is pressed horizontally across the forearm area, along the inside of the wrist, to maintain comfortable pressure on the P6 point throughout, as a strip rather than as an encircling band. The cutout 18 is centrally placed along the strip widthwise, from top-to-bottom, but offset lengthwise, from side-to-side. The contact button 20 includes a pressure sensitive adhesive backing 26 to adhere to the surgical adhesive lamination 14. The bottom 28 of the contact button 20 is then pressed, so that its raised portion 22 stimulates the P6 point beneath it. Within minutes the stimulation effect will occur. The process is then preferably repeated on the opposite wrist.

In use by the professional medical staff in putting on and then taking off the strip after use, a compress pressure is impacted to the contact button 20 on each wrist before the emetic stimulus or chemo medication is initiated. Investigation has shown that the P6 point is typically activated within 5 minutes from the time pressure is compressed on both contact buttons. After the procedure is completed, the relief strip is simply peeled away from the wrist and removed—heightened by the adhesive lamination being selected as hypoallergenic and skin contact friendly (i.e. latex-free).

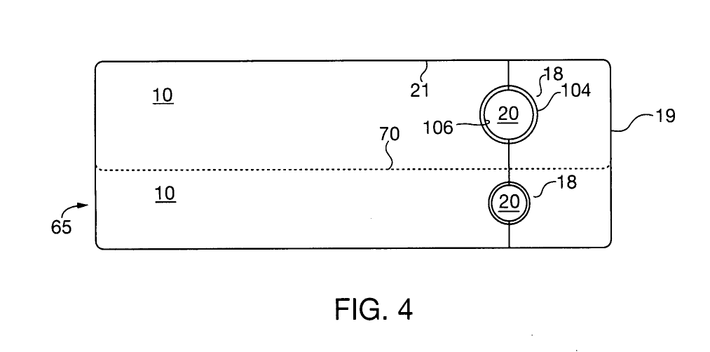

As will be appreciated by those skilled in the art, in dimensioning the relief strip of the invention, it is not necessary for the strip to wrap around the user's wrist as a band. What is necessary is that the strip be of sufficient length and width, and the contact button be of sufficient diameter (where the cutout 18 is circular), to overlap in being able to provide downward pressure of the raised contact dome portion 22 at the P6 pericardium point 60. In one construction of the disposable acupressure relief strip for use by a human, the following dimensions were found useful to meet FDA requests for acupressure relief:
Length 100 . . . 5.5 inches
Length 101 . . . 4.0 inches
Length 102 . . . 1.5 inches
Width 103 . . . 1.0 inches
Cutout Diameter . . . 0.58 inches
   In this manner, for the FIG. 4 packaging 65 of a pair of such relief strips 10 separated by a perforation 70 across the entire length of the strip, the cutouts 18 will be understood to be offset positioned slightly ½ of the length in from a right-hand end 19 of the adhesive lamination 14, but centrally positioned width-wise between its top edge 21 and its bottom edge, as formed by the perforation. Such positioning, along with a button diameter 106 of only slightly less than the cutout diameter 104 (for example 0.52 inches as compared to 0.58 inches), goes to ensure that movement activity of the wrist over time does not dislodge the raised dome portion 22 from the P6 pericardium point 60.

Testing has shown that with a dome height for the bottom 20 of some 0.27 inches and by the enabling of an acupressure at 5-7 pounds per square inch applied downwardly at the 0.5-1.00 inch pericardium point below the skin surface, an acupressure nausea protector of this configuration provides very satisfactory results for at least 72 hours, with or without the use of antisickness drugs. As will be apparent, besides being used to prevent postoperative nausea and vomiting, and chemo induced nausea and vomiting in a medical procedure environment, the acupressure relief strip of the invention could also be used as a preventer of travel motion sickness and of early pregnancy nausea as well.

When packaged with two such constructions in a heat sealed pouch as in FIG. 4, one for each wrist, the pouch can be accompanied with the following directions:
72 Hour Wrist Strip Nausea and Vomiting Relief for Adult Men & Women Intended for relief of nausea and vomiting symptoms related to surgery, chemotherapy, motion sickness and morning (pregnancy) sickness

### Product Instructions

The package includes an acupressure (green) locator guide and a set of wrist strips. You start with the (green) locator guide to identify the exact location of the P6 acupressure point on the inside of the wrist area. Then you apply the wrist strips. These strips are intended to be used up to 72 hours on both wrists.

Implementation of the wrist strips should begin approximately thirty (30) minutes prior to induction of anesthesia as follows:
Use the (green) locator guide with the arrow pointing to the hand.
Place the (green) locator guide on the middle area of the inside of the wrist beginning with the wrist crease nearest the hand.
Use your middle three fingers closely together on the center area of the wrist; ring finger first on the wrist crease near the hand on the locator guide to find the P6 acupressure point under the index finger (third finger down).
Under the index finger you will find the nearest open circle on the locator guide to mark the acupressure point location. Use the locator guide to mark both wrist areas.
Remove the liner from the wrist strip and apply the plastic button (face side down) on the indicated area on each wrist. Apply the short side of the clear adhesive first on the skin then the longer side across the wrist securely.

Greater relief can be gained by applying finger pressure on the plastic dome when necessary.

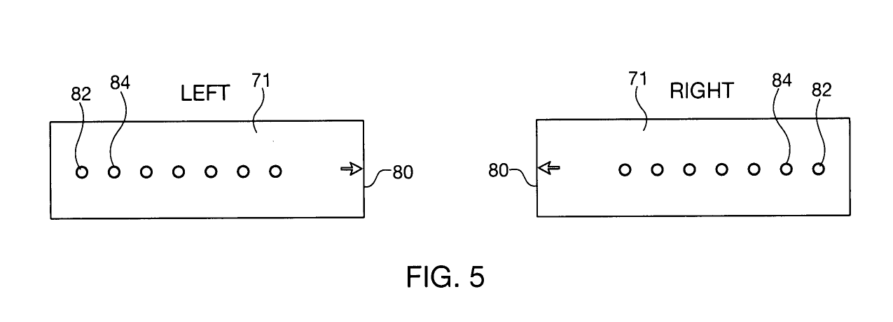

Two paper stock 1×3½ inch P6 locator guides 71 are included, as in FIG. 5, with one end 80 of each placed on the first wrist crease between the two tendons and with a series of perforated measurement indicators 82, 84, etc. to locate the P6 point 60 as in FIGS. 1a-1d. Specifically, FIG. 1a shows the P6 target area 70 between the dotted lines, starting downward from the wrist crease nearest the palm; FIG. 1b shows the placement of the P6 locator guide 71 on the targeted area; FIG. 1c shows the alignment of the patient's three fingers as indicated (with the ring finger on the first crease and index finger on the P6 pressure point); and FIG. 1d shows the placement of the plastic contact button 20 (with its dome 22 face down) on the P6 point, applying the wrist strip 10 securely across the wrist via its clear adhesive.

As such, the disposable acupressure relief strip of the invention provides up to 72 hours of clinically proven nausea and vomiting relief because of the position and size of the button, but also because the invention wrist strip does not wrap completely around the average human wrist size (i.e. 7¼ inches). This configuration allows the wrist strip to be flexible enough not to cause any potential tourniquet effect to the hand during the time of intended use (i.e. 72 hours).

While there have been described what are considered to be preferred embodiments of the present invention, it will be readily appreciated by those skilled in the art that modifications can be made without departing from the scope of the teachings herein of a hypoallergenic, skin contact friendly disposable strip which allows continuous acupressure stimulation for nausea protection. For at least such reason, therefore, resort should be had to the claims appended hereto for a true understanding of the scope of the invention.

I claim:

1. A disposable acupressure relief strip for the wrist of a user to mitigate the incidence of nausea and vomiting following one of a chemotherapy treatment or a surgical procedure, comprising:
a substrate of at least 5½ inch length and 1 inch width having a film bottom surface and an adhesive surgical tape top surface;
a paper liner overlying said adhesive surgical tape top surface;
a cutout through said paper liner to said adhesive surgical tape top surface; and
a hard plastic button having a pressure sensitive adhesive backing joined to said adhesive surgical tape top surface and a raised dome portion extending from said adhesive surgical tape top surface through said cutout;
with said cutout being centered substantially equally between top and bottom edges of said substrate and substantially 1½ inches in from a first side edge thereof and with said raised dome portion of said hard plastic button configured to extend through said cutout a distance of at least 0.27 inches.

2. The disposable acupressure relief strip of claim 1 wherein said paper liner is peelable away from said adhesive surgical tape top surface in a first direction along a first side of said cutout, and in a second direction along a second side of said cutout.

3. The disposable acupressure relief strip of claim 1 wherein said first edge of said substrate is adapted for alignment at the first wrist crease between the two wrist tendons of a user.

4. The disposable acupressure relief strip of claim 1 wherein said pressure sensitive adhesive backing of said hard plastic button is of a circular configuration of a 0.52 inch diameter, and wherein said cutout is of a circular configuration of a 0.58 inch diameter.

5. The disposable acupressure relief strip of claim 1 wherein said film bottom substrate is hypo-allergenic and tearable bi-directionally.

6. The disposable acupressure relief strip of claim 1 wherein said hard plastic button is of a composition bio-compatible with human skin use pressurizings.

7. The disposable acupressure relief strip of claim 6 wherein said hard plastic button is of a medical grade injection-molded plastic of a composition to exert downward pressurizing on the human skin of between 5 and 7 pounds per square inch.

8. The disposable acupressure relief strip of claim 6 wherein said hard plastic button is of a medical grade injection-molded plastic of a composition to exert downward pressurizing on the human skin of between 5 and 7 pounds per square inch at a depth of ½ to 1 inch below the skin surface.
